(19) United States
(12) Patent Application Publication
(10) Pub. No.: US 2006/0179155 A1
(43) Pub. Date: Aug. 10, 2006

(54) Web-based file transfer protocol server enterprise manager with build-in database

(76) Inventors: Harry E. Bunting, San Jose, CA (US); Peter G. Webb, Menlo Park, CA (US); Charles F. Nelson, San Carlos, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/051,782

(22) Filed: Feb. 4, 2005

(51) Int. Cl. G06F 15/173; G06F 15/16

(52) U.S. Cl. 709/232; 709/225

(57) ABSTRACT

Methods, systems and computer readable media for downloading data to file depository managed on a server. A user locates a remote server that hosts a file to be downloaded to the file depository using a web browser. A download request is submitted to the download queue, wherein the download queue is executed to download the file into the file depository. The system checks remote FTP sites and updates its file depository at specific intervals set by users and downloads the latest version of its file and archives old versions. The system allows users to upload files from the file depository to remote servers and updates the file depository if the file transfer was successful. All file transfer history for downloads/uploads may be viewable by client users.

### BACKGROUND OF THE INVENTION

Over the past decades, the Internet community has been growing at a remarkable rate. Established protocols are used to transmit large amounts of data over the Internet. Among the established protocols, File Transfer Protocol (FTP) is a prevailing method to transfer large data file information between geographically separated computers, where the size of data file is typically larger than 100 Mb. Even though a modern computer may have a built-in modem, LAN connection or wireless interface to connect to the Internet, directly connecting the computer to the Internet does not mean the computer can perform an FTP file transfer. The computer must have FTP software (client application) in order to perform an FTP transfer.

Off-the-shelf client applications, such as Microsoft Internet Explorer™, CuteFTP™, Ipswitch WS-FTP™, HyperSend, provide a user interface that FTP transfer files from one computer to anther. These applications are saved in the users' “Program Files” directories. Typically, such applications may use one of the following methods: 1) Dragging files from one window to anther window on the same computer (e.g., Microsoft Internet Explorer™). 2) Entering a remote FTP Server path, the path to save the file on your computer, user logon, password and download schedule in multiple window dialog boxes, and then select FTP download. The client software may retain this information when the application is closed and continue to FTP transfer on schedule when the client program is exited. FTP download/upload history may be provided by the client application while it is open. 3) Writing software scripts to specify FTP parameters that conform to the client application software to provide similar results as in the method 2). 4) A “Secure FTP Server” may be provided that works in conjunction with its “client” application to “enhance” FTP file transfer security.

Such conventional off-the-shelf FTP client applications have disadvantages. Every user has to purchase a licensed FTP application software that can cost $40+ per copy and install it on their computer through an operating system, such as WINDOWS XP™ or the like. Also, as the conventional software is installed on each user's personal computer, it is not typically integrated with a database and does not provide multi-user access. In addition, “Secure FTP Server” licenses can be as much as $400 per server. Thus, a typical organization needs to spend a considerable amount of expense to provide licensed FTP transfer software for its employees. “Client” users may FTP a large quantity of data files to their company hard disks and/or their PCs. Sometimes, multiple copies of identical and/or different file revisions may be scattered on many company disk drives. Typically, no one except the user who downloaded the files knows where the downloaded files are stored. If there is no organization to the downloaded files on computer disks, such duplicated storage of files can translate into a large amount of expense to purchase and operate additional disk space. An old revision file might be accessed causing data reliability issues. Thus, there is a strong need for a system to eliminate the need to purchase any FTP “client” application software and to manage the downloaded files so that the disk space can be used in an optimized manner with the latest files.

Another disadvantage of conventional applications is that each user has to go through a learning curve. Users, who are not familiar with the FTP client application, would not know what to do, and due to complex operations, it may be inefficient. Every user who FTP transfers files may be required to become an FTP application download administration expert and write a script that is specific to each computer environment. Writing scripts for FTP transfer may be essentially “programming” the FTP “client” application and require a considerable depth of knowledge in FTP as well as the operating system. In addition, even successful script programmers (or system administrators) are sometimes required to run Windows “Task Schedulers” repeatedly to run different scripts at designated times.

Yet another disadvantage of the conventional software is that filling in multiple dialog boxes open for user input may result in errors if there is no feedback mechanism to check the user input. Also, in an organization, different users may schedule to download the same file multiple times if the software cannot provide a complete view of all files scheduled for FTP download, history of the FTP downloads and schedules for updating files. Thus, there is a need for a system that allows client users to FTP transfer files, view file transfer history, schedules and upload files with a limited number of mouse clicks instead of writing FTP scripts, wherein the system preferably uses a standard Internet browser as a user interface.

### SUMMARY OF THE INVENTION

Systems, methods and computer readable media are provided that allow one or more users to download files over the Internet to a predetermined master directory without purchasing FTP client application software and writing FTP scripts, wherein the users are allowed to view file transfer history, schedules and download/upload files with a limited number of mouse clicks. The users enter their ID information, such as their names and projects, into the system, referred to as the “Large File Transfer System” (LFTS) to keep track of who is requesting a download and what they are downloading, select remote FTP sites, and designate a subdirectory under the master directory to save the downloaded file. One copy of LFTS software, the database (SQL, Oracle, DBII, Microsoft Access or others), file directory structure and archive directory is installed on a Server and thousands of clients can access its capabilities via the Web. The LFTS system administrator enters parameters in the LFTS database using a web page to immediately perform FTP transfers, delete files from the database and directories, edit user inputs and change download schedules. The LFTS system communicates with a user via web pages displayed on the user's client system. Each user can upload any files downloaded into the master directory and visible in the database to his personal computer.

In one embodiment of the present invention, a server system for managing transfer of files over a public network includes: a file depository for centrally storing a plurality of files downloaded over the network; and software configured to control downloading the plurality of files via a web-based user interface and centrally organizing storage of the plurality of files on the file depository.

In another embodiment of the present invention, methods and computer readable media are provided for downloading data. In response to receiving a download request for a file, the download request is added to a download queue. Then, the file to be downloaded is compared with one or more files contained in a file depository to determine if the file already exists in the file depository. If the file is not already in the file depository, the file is downloaded into the file depository.

A user locates a remote FTP server that hosts a file to be downloaded using their web-based interface (browser). Then, the user selects the filename and submits a download request to a download queue.

In still another embodiment of the present invention, methods and computer readable media are provided for managing a database and a file depository that stores a plurality of files downloaded. A server provides information regarding the plurality of files to at least one client and receives a download request for a specific file from the at least one client if the specific file does not exist in the server. Next, the download request is added to a download queue, wherein the download queue is executed to download the specific file to the file depository. Upon competition of the file transfer, the file depository and the database containing the information are updated with file transfer details.

In yet another embodiment of the present invention, methods and computer readable media are provided for uploading files to a remote FTP server. A user locates a remote FTP server configured to receive a file to be uploaded using a web-based user interface and submit an upload request for the file to an upload queue. Subsequently, an LFTS program code executes the upload queue to upload the file into the remote FTP server. Upon completion of the file upload, the LFTS program code updates the FTP history data.

These and other advantages and features of, the invention will become apparent to those persons skilled in the art upon reading the details of the invention as more fully described below.

### BRIEF DESCRIPTION OF THE DRAWINGS

FIG. 1 shows a schematic diagram of an exemplary computer that may be used in embodiments of the present invention.

FIG. 2 schematically illustrates a system environment in accordance with an embodiment of the present invention.

FIG. 3A is a schematic diagram of an LFTS web page that displays the information of downloaded files in accordance with one embodiment of the present invention.

FIG. 3B is a schematic diagram of an LFTS web page that allows a user to browse the downloaded files in a hierarchically organized structure in accordance with one embodiment of the present invention.

FIG. 4 is a schematic diagram of an LFTS web page that allows a user to select one of a plurality of remote servers in accordance with one embodiment of the present invention.

FIG. 5 is a schematic diagram of an LFTS web page that accepts user inputs to create a download request in accordance with one embodiment of the present invention.

FIG. 6 is a schematic diagram of an LFTS web page that allows an administrator to view and modify a download schedule in accordance with one embodiment of the present invention.

FIG. 7 is a schematic diagram of an LFTS web page that displays a download history of files in accordance with one embodiment of the present invention.

FIG. 8 is a schematic diagram of an LFTS web page that allows a user to view a download schedule in accordance with one embodiment of the present invention.

FIG. 9 is a flow chart illustrating user steps that may be carried out to download a file in accordance with one embodiment of the present invention.

FIG. 10 is a flow chart illustrating server steps that may be carried out to download a file into a file depository and manage the file depository in accordance with one embodiment of the present invention.

FIG. 11 is a schematic diagram of an LFTS Web page showing the fields filled in by a user to upload a file to a remote server in accordance with one embodiment of the present invention.

FIG. 12 is a schematic diagram of an LFTS Web page displaying all files uploaded to remote servers in accordance with one embodiment of the present invention.

FIG. 13 is a schematic diagram of an LFTS Web page displaying upload schedules to remote servers in accordance with one embodiment of the present invention.

FIG. 14 is a flow chart illustrating steps that may be carried out to upload a file in accordance with one embodiment of the present invention.

### DETAILED DESCRIPTION OF THE INVENTION

Before the present systems and methods are described, it is to be understood that this invention is not limited to particular data, software, hardware or method steps described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise. Thus, for example, reference to “a user” includes a plurality of such users and equivalents thereof known to those skilled in the art, and so forth.

Definitions

When one item is indicated as being “remote” from another, this is referenced that the two items are in different locations, i.e., at least in different rooms, at least in different buildings, and may be at least one mile, ten miles, or at least one hundred miles apart.

“Communicating” information references transmitting the data representing that information as signals (e.g., electrical, optical, radio, etc,) over a suitable communication channel (for example, a private or public network).

A “processor” references any hardware and/or software combination which will perform the functions required of it. For example, any processor herein may be a programmable digital microprocessor such as available in the form of a mainframe, server, or personal computer. Where the processor is programmable, suitable programming can be communicated from a remote location to the processor, or previously saved in a computer program product. For example, a magnetic or optical disk may carry the programming, and can be read by a suitable disk reader communicating with each processor at its corresponding station.

Reference to a singular item, includes the possibility that there are plural of the same items present.

“May” means optionally.

Methods recited herein may be carried out in any order of the recited events which is logically possible, as well as the recited order of events.

All patents and other references cited in this application are incorporated into this application by reference except insofar as they may conflict with those of the present application (in which case the present application prevails).

Being computer-related, it can be appreciated that the components disclosed herein may be implemented in hardware, software, or a combination of hardware and software (e.g., firmware). Software components may be in the form of computer-readable program code stored in a computer-readable storage medium, such as memory, mass storage device, or removable storage device. For example, a computer-readable storage medium may comprise computer-readable code for performing the function of a particular component. Likewise, computer memory may be configured to include one or more components, which may then be executed by a processor. Components may be implemented separately in multiple modules or together in a single module.

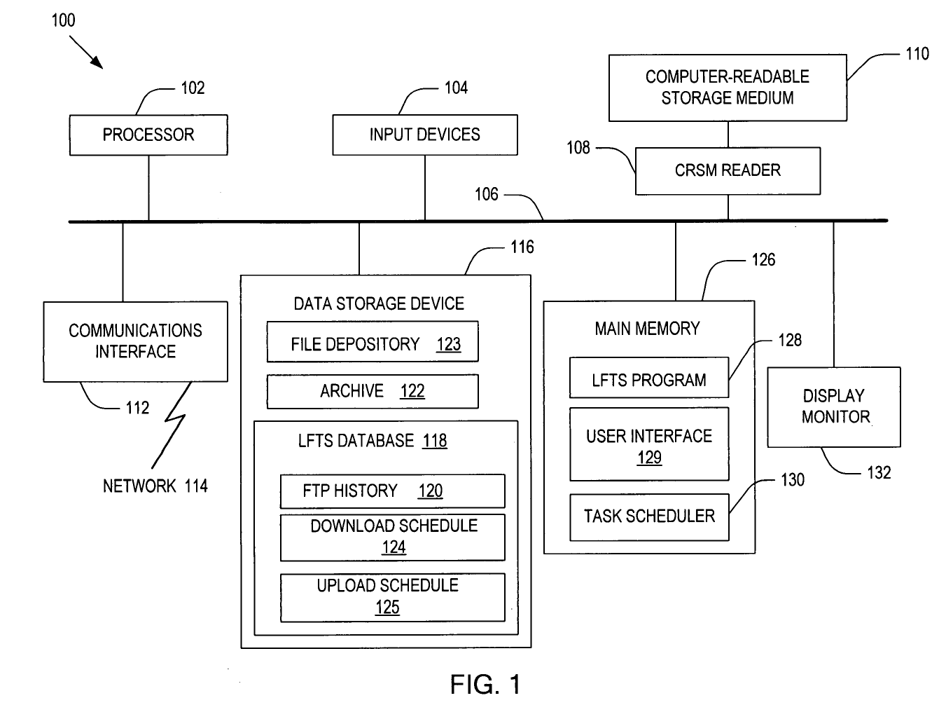

Referring now to FIG. 1, there is shown a schematic diagram of an exemplary computer 100 that may be used in embodiments of the present invention. Depending on its configuration, computer 100 may be employed as a client computer or a server computer, for example. Computer 100 may have less or more components to meet the needs of a particular application. As shown in FIG. 1, computer 100 may include processor 102, such as those from the Intel Corporation or Advanced Micro Devices, for example. Computer 100 may have one or more buses 106 coupling its various components. Computer 100 may include one or more input devices 104 (e.g., keyboard, mouse), computer-readable storage medium (CRSM) 110, CRSM reader 108 (e.g., floppy drive, CD-ROM drive), display monitor 132 (e.g., cathode ray tube, flat panel display), communication interface 112 (e.g., network adapter, modem) for coupling to network 114, one or more data storage devices 116 (e.g., hard disk drive, optical drive, FLASH memory), and main memory 126 (e.g., RAM). Software embodiments may be stored in a computer-readable storage medium 110 for reading into a data storage device 116 or main memory 126. In the example of FIG. 1, main memory 126 may be configured to include task scheduler 130, Large File Transfer System (LFTS) program 128 and user interface 129, wherein user interface 129 may be a web-based interface program and include a graphic user interface, such as web-pages. Data storage device 116 may include file depository 123 for storing downloaded files, archive 122 for storing outdated versions of data and LFTS database 118 of any type that may be managed by LFTS program 128, wherein LFTS database 118 may store FTP (download and/or upload) history data 120, download schedule data 124 and upload schedule data 125. In one embodiment, FTP history data 120 and file depository 123 may be consolidated so that each file may carry its FTP history information. In another embodiment, user interface 129 may be included in LFTS program 128.

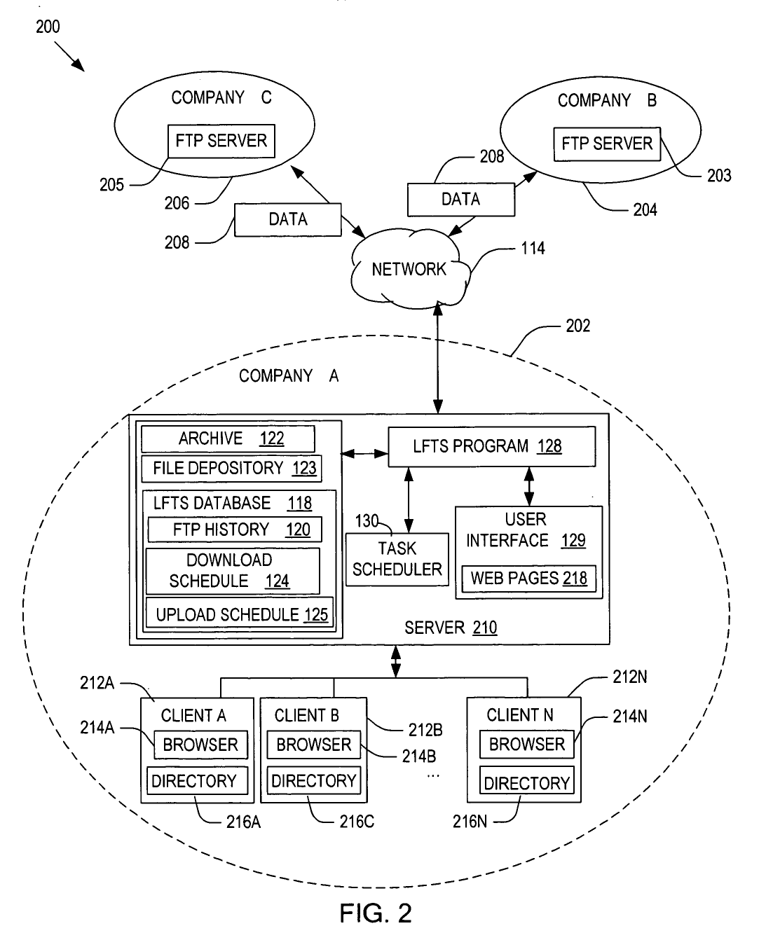

Referring now to FIG. 2, there is shown a schematic diagram of a system environment 200 in accordance with an embodiment of the present invention. Server 210 of company A 202 may transfer data 208 from file servers 203 and 205 of companies B-C 204 and 206, respectively. In an alternative embodiment, the server 210 may not be an FTP server, but is connected to a separate FTP server. Data 208 may include any type of data file. Thus, hereinafter, the terms “file” and “data” are used interchangeably. Also, the term “company” refers to any organization or any individual web host that has an FTP server with a capability to send and/or receive data through network 114. It is noted that server 210 is described as a server for downloading files in the following sections. However, server 210 may be used as a server hosting data to other companies.

In system environment 200, only three companies are shown for clarity and ease of illustration. However, it should be apparent to those of ordinary skill in the art that the invention can be practiced with any number of companies. The network 114 may include the Internet or other suitable connection systems for exchanging data 208. The company A 202 can be different from company B 204, or a branch of company B 204.

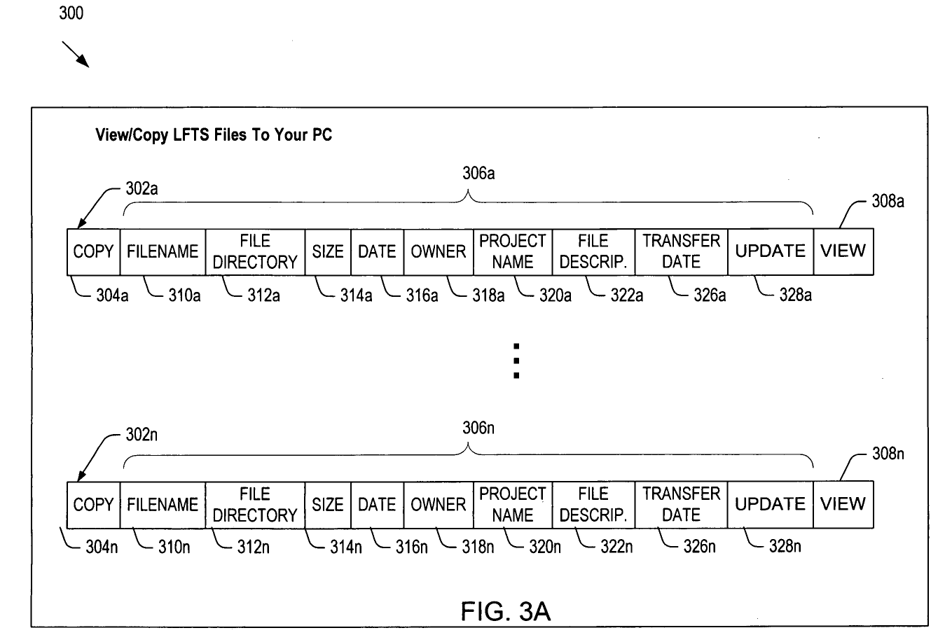

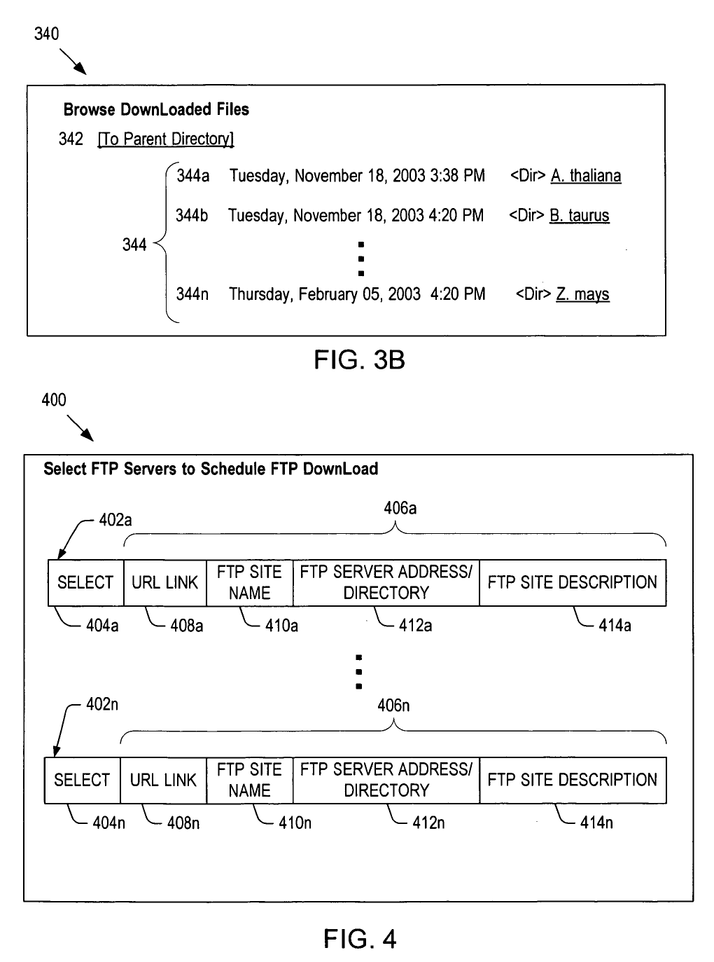

Server 210 may be connected to and communicate with one or more clients 212a-n using user interface 129, wherein each client 212 (e.g., 212a, . . . , 212n) may be a server or a PC. In one embodiment, user interface 129 may include one or more web pages 218 displayed on web browsers 214a-n, such as Internet Explorer™, of clients 216a-n. Further details of web pages 218 may be given in connection with FIGS. 3A-8. In this embodiment, web pages 218 may be exclusively provided to clients 216a-n within company A 202. In another embodiment, web pages 218 may be open to limited companies. In still another embodiment, web pages 218 may be public over the Internet.

The server 210 may receive and store data 208 in file depository 123. In existing systems, a user of one client, say 212a, may receive and store data 208 anywhere in server 210 or directory 216a. Typically, a user of another client, say 212b, may attempt to download the same data as downloaded by client 212a without knowing that server 210 already has the data, even though the user of client 212b also has a full access to the data. Such redundant file transfer is eliminated by LFTS checking all directories and subdirectories for file existence. Hereinafter, the terms directory(ies)/subdirectory(ies) and file depository may be interchangeably used. The first client to download the file becomes the winner and other clients receive a “File already exists” error. In contrast, in one embodiment of the present invention, the users of clients 212a-n may download data 208 into file depository 123 in the first step. In this step, LFTS program 128 may control the flow of file transfer through the server 210 and manage LFTS database 118 to optimize the use of the file depository 123. Also, LFTS program 128 may update FTP history 120 and download schedule 124. When server 210 receives and stores data into file depository 123, the users of clients 212a-n may share the data and/or upload a copy into their own file directories 216a-n in the next step.

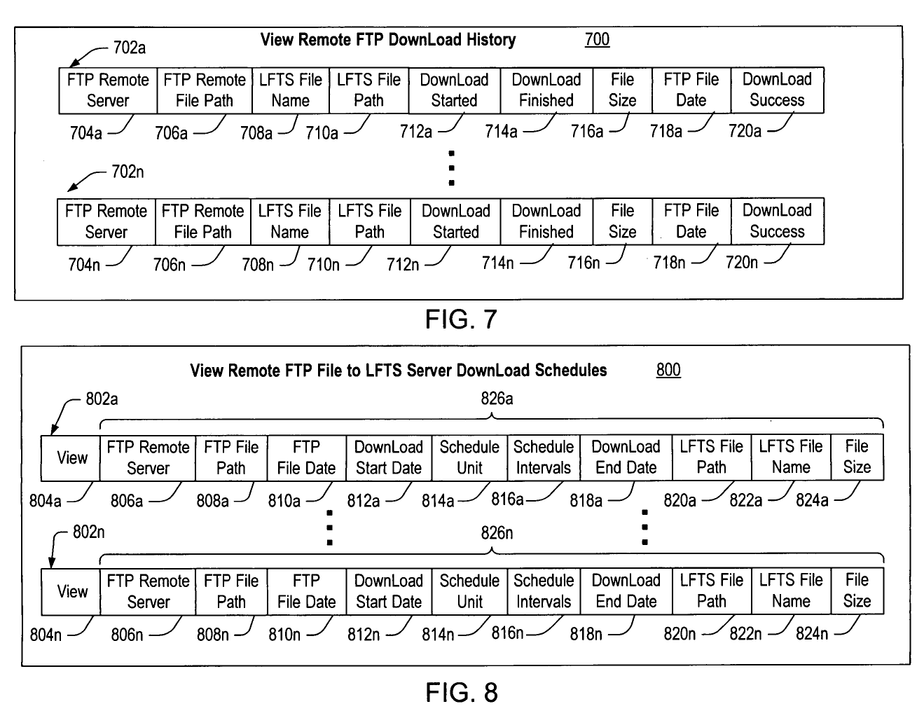

As mentioned, LFTS program 128 may communicate with clients 212a-n using LFTS web pages 218 displayed on browsers 214a-n and manage LFTS database 118 based on the communication. FIG. 3A is a schematic diagram of an LFTS web page 300 that displays the information of downloaded files on browser 214a-n in accordance with one embodiment of the present invention. LFTS web page 300, referred to as View page 300, may display data in a table format, where each row 302 (e.g., 302a, . . . , 302n) may correspond to a file stored in file depository 123 and/or archive 122. Each row 302 (e.g., 302a, . . . , 302n) may have “Copy” button 304 (e.g., 304a, . . . , 304n), File Information field 306 e.g., 306a, . . . , 306n) and “View” button 308 (e.g., 308a, . . . , 308n), wherein File Information field 306 (e.g., 306a, . . . , 306n) may include File Name 310 (e.g., 310a, . . . , 310n), File Directory 312 (e.g., 312a, . . . , 312n), File Size 314 (e.g., 314a, . . . , 314n), Date 316 (e.g., 316a, . . . , 316n), File Owner 318 (e.g., 318a, . . . , 318n), Project Name 320 (e.g., 320a, . . . , 320n), File Description 322 (e.g., 322a, . . . , 322n), Transfer Date 326 (e.g., 326a, . . . , 326n) and the time of Update 328 (e.g., 328a, . . . , 328n). Copy button 304 (e.g., 304a, . . . , 304n) may allow the user to upload a copy of the file into directory 216. When a user clicks View button 308 (e.g., 308a, . . . , 308n), a new web page, referred to as Download History page, an embodiment 700 of which is detailed in FIG. 7, may be opened displaying a download history of the file. It is noted that each of the LFTS web pages 218 may include hypertext links that lead to other LFTS web pages by clicking a mouse. However, for simplicity, these hypertext links are not shown in FIGS. 3A-8.

FIG. 3B is a schematic diagram of an LFTS web page 340 that allows a user to browse the files stored in server 210 in accordance with one embodiment of the present invention. LFTS web page 340, referred to as Browser page 340, may display files and directories of LFTS database 118 in a hierarchically organized structure. For example, a user may click a hypertext link on line 342 to move up to the parent directory. Likewise, the user may click a hypertext link on lines 344b to view the subdirectories of directory “B. taurus.” The time information on each line 344 (e.g., 344a, . . . , 344n) may indicate the most recent update of the corresponding directory.

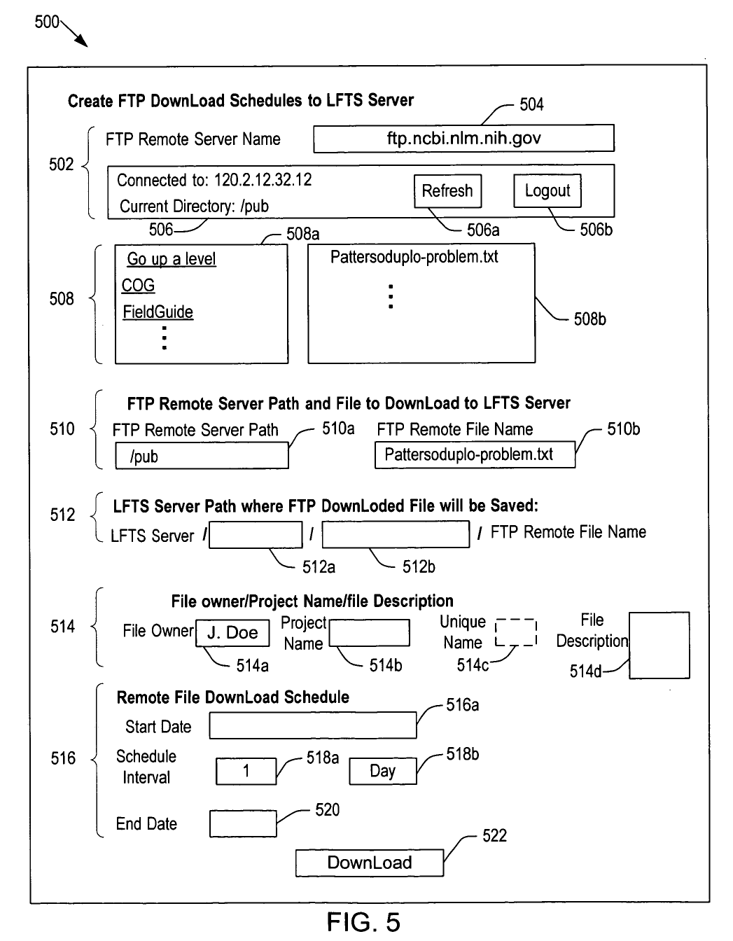

FIG. 4 is a schematic diagram of an LFTS web page 400 that allows a user to select one of a plurality of remote servers in accordance with one embodiment of the present invention. LFTS web page 400, referred to as Select FTP Server page 400, may display FTP remote server information in a table format, wherein each row 402 (e.g., 402a, . . . 402n) may correspond to a remote server that hosts data. Each row 402 (e.g., 402a, . . . 402n) may have “Select” button 404 (e.g., 404a, . . . , 404n) and Remote Server Information field 406 (e.g., 406a, . . . , 406n), wherein Remote Server Information field 406 (e.g., 406a, . . . , 406n) may include URL link 408 (e.g., 408a, . . . , 408n), FTP Site Name 410 (e.g., 410a, . . . , 410n), FTP Server Address/Directory 412 (e.g., 412a, . . . , 412n) and FTP Site Description 414 (e.g., 414a, . . . , 414n). A user may click Select button 404 (e.g., 404a, . . . , 404n)to open a new web page (as illustrated in FIG. 5) and schedule a download.

FIG. 5 is a schematic diagram of an LFTS web page 500 that accepts user input to create a download request in accordance with one embodiment of the present invention. LFTS web page 500, referred to as Create FTP Download Schedule page 500, may be opened by clicking Select button 404. As illustrated in FIG. 5, Create FTP Download Schedule page 500 may include: FTP Remote Server section 502 including FTP Remote Server Name field 504 and FTP Remote Server Information box 506; FTP Remote Server Directory/File section 508; FTP Remote Server Path section 510; LFTS Server Path section 512; LFTS File Information section 514; Remote File Download Schedule section 516; and “Download” button 522 that allows the user to confirm the download request and send the download request to a download queue.

FTP Remote Server Information box 506 may include a display of an IP address of a remote server, a display of the current directory in the remote server, “Refresh” button 506a for refreshing the contents in FTP Remote Server Information box 506, and “Logout” button 506b to exit Create FTP Download Schedule page 500. FTP Remote Server Name 504 may be a user input field and automatically display the information of FTP Server Address/Directory 412 by default when Create FTP Download Schedule page 500 is opened.

FTP Remote Server Directory/File section 508 may display directories and files of the remote server in a hierarchical structure. Directory list 508a may display a list of directories in the remote server, while File list 508b may display a list of files in the directory selected from Directory list 508a. FTP Remote Server Path section 510 may include FTP Remote Server Path field 510a and FTP Remote File Name field 510b. The contents displayed in the fields 510a and 510b may be the same as the directory and file name selected in Directory list 508a and File list 508b, from which a user may select a directory and a file name by clicking a mouse button.

LFTS Server Path section 512 may include two input fields 512a and 512b. These two input fields 512a-b may specify the directory path where the downloaded file is to be located in file depository 123. LFTS File Information section 514 may include three or more input fields; File Owner field 514a, Project Name field 514b, and File Description field 514d. Optionally, other input fields, such as Unique names 514c, may be present on this web page. Upon completion of download, the information in LFTS Server Path section 512 may appear in File Information field 306 in FIG. 3A. Remote File Download Schedule section 516 may include four or more input fields: Start Date field 516a; Schedule Interval Unit list 518a; Schedule Interval Type list 518b; and End Date field 520.

The information input to Create FTP Download Schedule page 500 may become parameters of a download request. Subsequently, the download request may be added to a download queue stored in download schedule data 124 (shown in FIGS. 1-2). The administrator of server 210 may set the task scheduler 130 time of day to execute the download queue. Task scheduler 130 may be set to run at any time of day, typically late night, to not interfere with daily operation of server 210. Upon completion of download, the information input to Create FTP Download Schedule page 500 may be stored in FTP history data 120 and may be accessed by clients 212 via View Download History page 700, as will be explained in connection with FIG. 7.

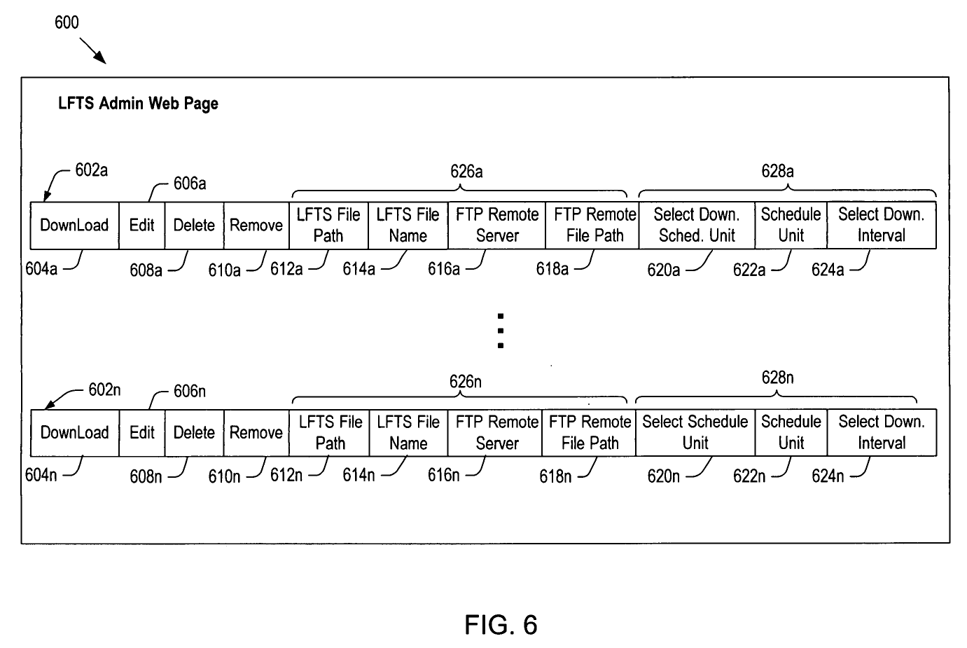

FIG. 6 is a schematic diagram of an LFTS web page 600 that allows an administrator to view and modify a download schedule in accordance with one embodiment of the present invention. LFTS web page 600, referred to as Administration page 600, may be opened by clicking on a hypertext link displayed on each of LFTS web pages 218. Administration page 600 may display data in a table format, where each row 602 (e.g., 602a, . . . , 602n) may correspond to a download request in a download queue (or, equivalently, download schedule) stored in download schedule data 124. Each row 602 (e.g., 602a, . . . , 602n) may include “Download” button 604 (e.g., 604a, . . . , 604n), “Edit” button 606 (e.g., 606a, . . . , 606n), “Delete” button 608 (e.g., 608a, . . . , 608n), “Remove” button 610 (e.g., 610a, . . . , 610n), File Information field 626 (e.g., 626a, . . . , 626n) and Schedule Modification field 628 (e.g., 628a, . . . , 628n). File Information field 626 (e.g., 626a, . . . , 626n) may include LFTS File Path 612 (e.g., 612a, . . . , 612n), LFTS File Name 614 (e.g., 614a, . . . , 614n), FTP Remote Server Path 616 (e.g., 616a, . . . , 616n) and FTP Remote File Path 618 (e.g., 618a, . . . , 618n). The LFTS File Path 612 (e.g., 612a, . . ., 612n) may indicate a directory within file depository 123 where the downloaded file is to be stored. Schedule Modification field 628 (e.g., 628a, . . . , 628n) may include two or more selection lists; Select Download Schedule Unit list 620 (e.g., 620a, . . . , 620n), Select Download Interval list 624 (e.g., 624a, . . . , 624n), and Schedule Unit 622 (e.g., 622a, . . . , 622n). Select Download Schedule Unit list 620 (e.g., 620a, . . . , 620n) and Select Download Interval list 624 (e.g., 624a, . . . , 624n) may display a list of numbers and a list of time units, respectively, where a user can select one from each of the lists. The number selected from Select Download Schedule Unit list 620 (e.g., 620a, . . . , 620n) may be displayed in Schedule Unit 622 (e.g., 622a, . . . , 622n).

FIG. 7 is a schematic diagram of an LFTS web page 700 that displays download history of files in accordance with one embodiment of the present invention. LFTS web page 700, referred to as View Download History page 700, may be opened by clicking View button 308 (shown in FIG. 3A) and display FTP history data 120 (shown in FIG. 2). View Download History page 700 may be displayed in a table format, wherein each row 702 (e.g., 702a, . . . , 702n) may correspond to a file stored in file depository 123 and archive 122, and include FTP Remote Server 704 (e.g., 704a, . . . , 704n), FTP Remote File Path 706 (e.g., 706a, . . . , 706n), LFTS File Name 708 (e.g., 708a, . . . , 708n), LFTS File Path 710 (e.g., 710a, . . . , 710n) for indicating the directory within file depository 123 where the file is stored, Download Started 712 (e.g., 712a, . . . , 712n), Download Finished 714 (e.g., 714a, . . . , 714n), File Size 716 (e.g., 716a, . . . , 716n), FTP File Date 718 (e.g., 718a, . . . , 718n) and Download Success 720 (e.g., 720a, . . . , 720n). As FTP is used typically to download a large quantity of text data file information, it may be necessary to check the integrity of the downloaded text data and display the checked integrity in an information field, such as Download Success 720 (e.g., 720a, . . . , 720n).

FIG. 8 is a schematic diagram of an LFTS web page 800 that allows a user to view a download schedule in accordance with one embodiment of the present invention. LFTS web page 800, referred to as View Download Schedule page 800, may display data in a table format, wherein each row 802 (e.g., 802a, . . . , 802n) may correspond to a download request in a download queue stored in download schedule data 124. Each row 802 (e.g., 802a, . . . , 802n) may have “View” button 804 (e.g., 804a, . . . , 804n) and Download Information field 826, wherein Download Information field 826 may include FTP Remote Server 806 (e.g., 806a, . . . , 806n), FTP Remote File Path 808 (e.g., 808a, . . . , 808n), FTP File Date 810 (e.g., 810a, . . . , 810n), Download Start Date 812 (e.g., 812a, . . . , 812n), Schedule Unit 814 (e.g., 814a, . . . , 814n), Schedule Intervals 816 (e.g., 816a, . . . , 816n), Download End Date 818 (e.g., 818a, . . . , 818n), LFTS File Path 820 (e.g., 820a, . . . , 820n), LFTS File Name 822 (e.g., 822a, . . . , 822n) and File Size 824 (e.g., 824a, . . . , 824n). A user may click View button 804 to view the details of download schedule and change download parameters.

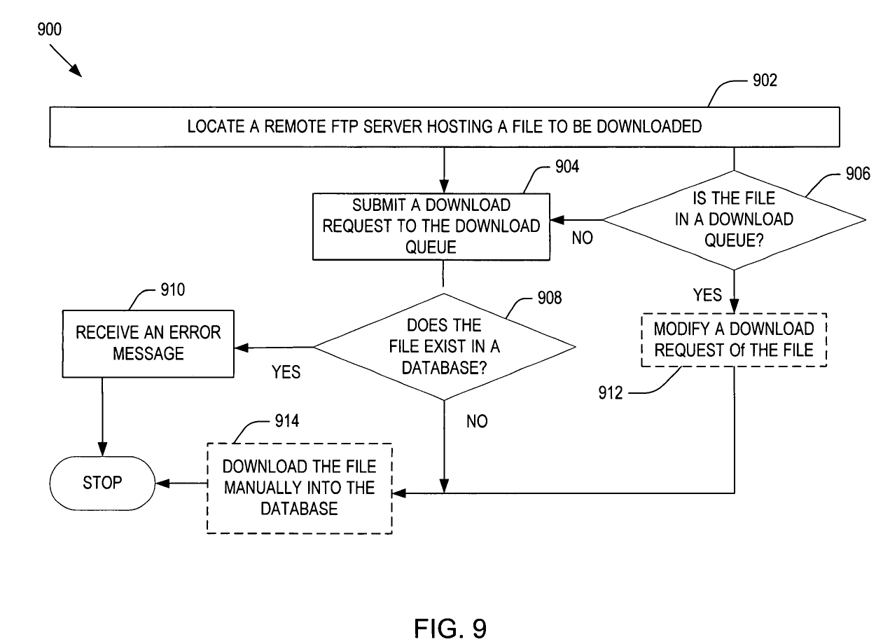

FIG. 9 is a flow chart 900 illustrating user steps that may be carried out to download a file into file depository 123 in accordance with one embodiment of the present invention. At step 902, a user of client 212 may locate a remote FTP server hosting a file to be downloaded. Then, the user may open a Create Download Schedule page 500 to submit a download request at step 904. Next, an LFTS program will check if the file depository 123 already has the file at step 908. If the answer to the step 908 is YES, the user may get a duplicate file error message at step 910 and the process stops. Otherwise, the LFTS program may download the file as specified in the download request.

Optionally, the user may open a View Download Schedule page 800 to check if a download request for the file has been already submitted to a download queue in the LFTS database at step 906. If the answer to step 906 is positive, the user may wait until the file is downloaded and stored in file depository 123. As an optional step 912, the user may modify the download request in the download queue. If the answer to step 906 is negative, the user may proceed to step 904 to submit a download request. As an optional step 914, the administrator of the LFTS database may manually download the file in the download queue. Upon completion of the file download, the user may upload the file into directory 216 of client 212.

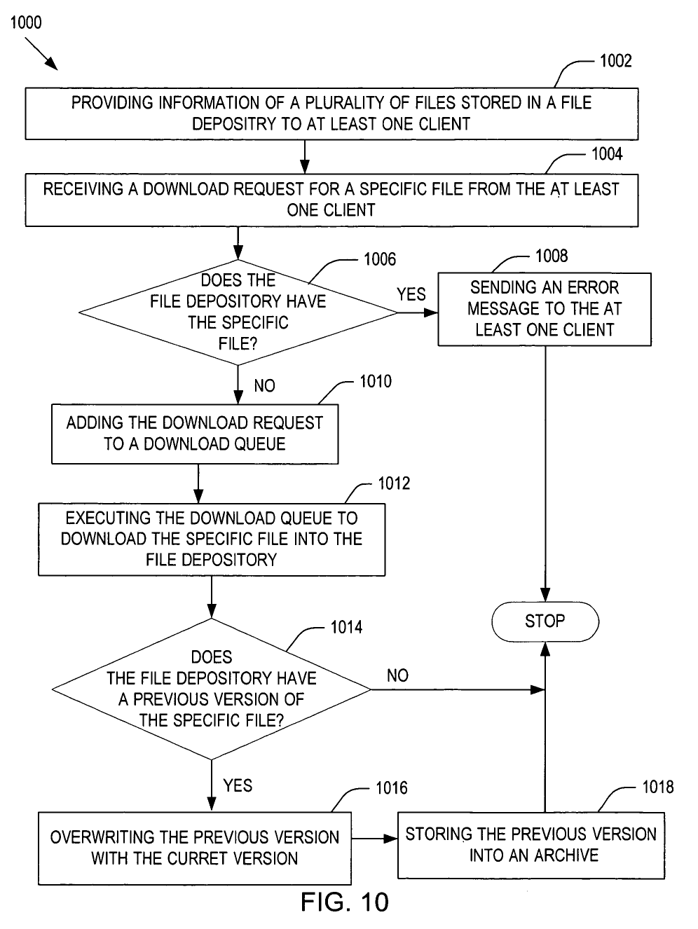

FIG. 10 is a flow chart 1000 illustrating server steps that may be carried out to download a file, update and manage a file depository in accordance with one embodiment of the present invention. A server, such as the server 210 shown in FIG. 2, may provide information of the files stored in a file depository for a client via a plurality of web pages at step 1002. Then, client user may browse the web pages to determine if the file depository has a file of interest. If the user cannot find the file in the file depository, the user may submit a download request. At step 1004, the server may receive the download request for the file from the client. In some cases, a different user may inadvertently submit a duplicate download request for the file. To obviate such duplicate download, the server may check if the file depository has the file at step 1006. If the answer to the step 1006 is YES, the server may send a duplicate file error message to the client at step 1008 and the process stops. Otherwise the process may proceed to step 1010. At step 1010, the server may add the download request to a download queue.

As mentioned, an administrator of the server may set the server task scheduler time of day to execute the download queue. At step 1012, the task scheduler may perform FTP transfers as required by the file parameters of the download request. To execute the download request, an LFTS program may compare a current date with a download date specified in the download request and, if the current date is earlier than the download date, the task scheduler may download the file specified in the download request. Then, the process proceeds to step 1014.

At step 1014, LFTS program determines if the file depository has a previous version of the file by comparing the file dates of the previous and current versions of the file. If the answer to step 1014 is positive, the previous version may be replaced with the current version at step 1016. Subsequently, the previous version may be sent to an archive at step 1018.

It is noted that the present invention provides systems and methods to download files using FTP. However, it should be apparent to those of ordinary skill that other types of File Transfer Protocol, such as Hypertext Transfer Protocol (HTTP), Hypertext Transfer Protocol Secure (HTTPS), Secure Socket Layer (SSL), Secure Shell (SSH), and Secure FTP, may be used without deviating from the present teachings.

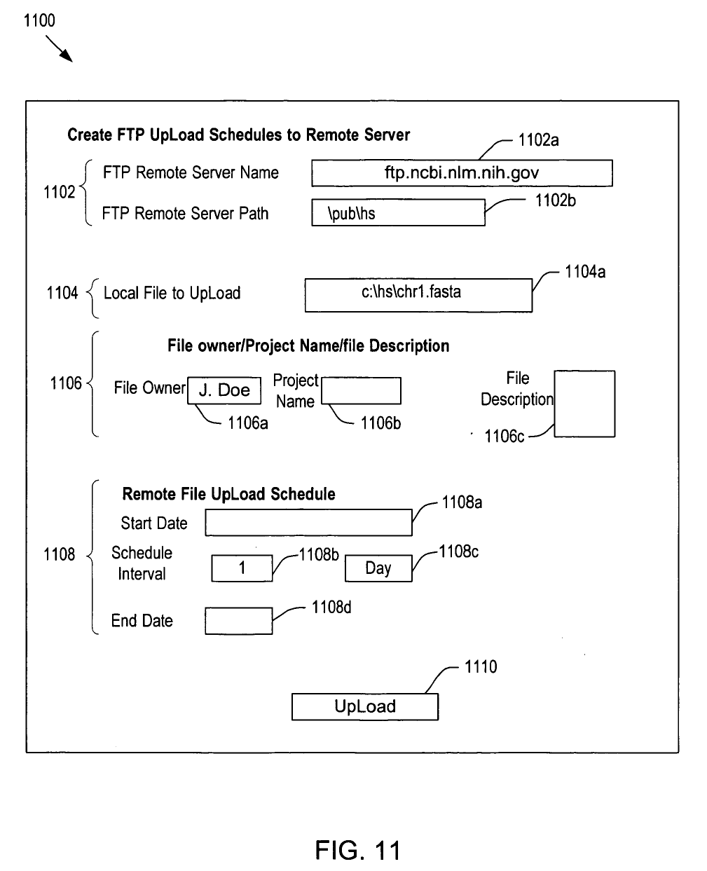

FIG. 11 is a schematic diagram of an LFTS web page 1100, referred to as Create FTP Upload Schedule page 1100, that accepts user input to create an upload request in accordance with one embodiment of the present invention. As illustrated in FIG. 11, Create FTP Upload Schedule page 1100 may include: FTP Remote Server section 1102; Local File to Upload section 1104; LFTS File Information section 1106; Remote File Upload Schedule section 1108; and “Upload” button 1110 that allows the user to confirm the upload request and send the upload request to an upload queue.

FTP Remote Server section 1102 may include FTP Remote Server Name field 1102a and FTP Remote Server Path field 1102b that may be selected by a user to designate the location where the uploaded file will be transferred. Local File to Upload section 1104 may include Local File to Upload field 1104a that allows the user to select the full path of the local users' file to upload. LFTS File Information section 1106 may include three or more input fields; File Owner field 1106a, Project Name field 1106b, and File Description field 1106c. Remote File Upload Schedule section 1108 may include four or more input fields: Start Date field 1108a; Schedule Interval Unit list 1108b; Schedule Interval Type list 1108c; and End Date field 1108d.

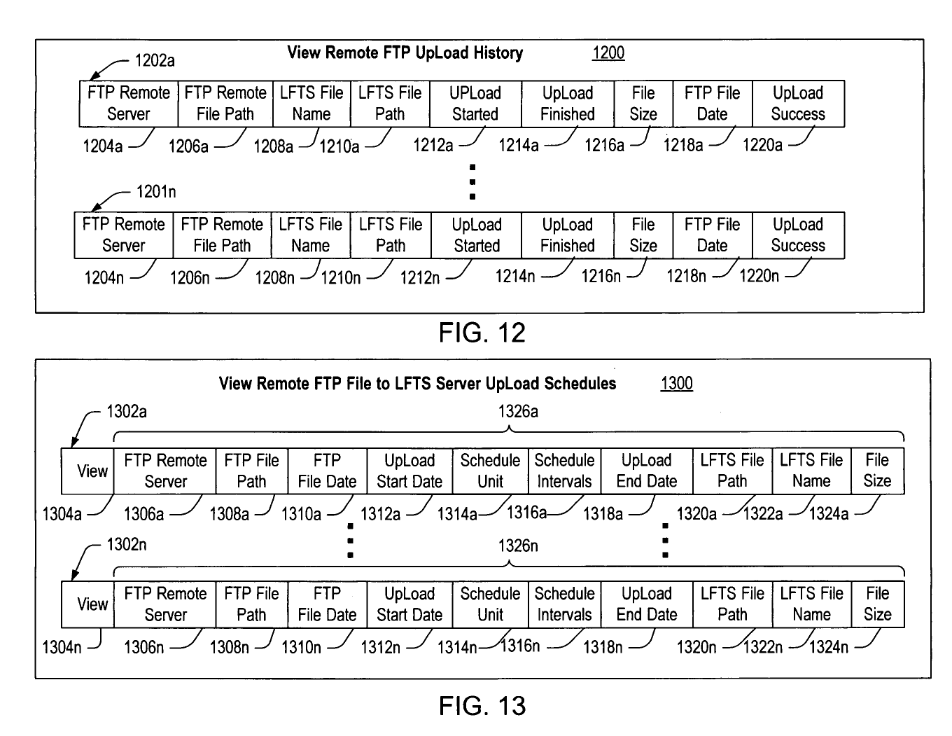

The information input to Create FTP Upload Schedule page 1100 may become parameters of an upload request. The upload request submitted via Create FTP Upload Schedule page 1100 may be added to an upload queue (or, equivalently, upload schedule) stored in upload schedule data 125 (shown in FIGS. 1-2). The administrator of server 210 may set the task scheduler 130 time of day to execute the upload queue. Task scheduler 130 may be set to run at any time of day, typically late night, to not interfere with daily operation of server 210. Upon completion of upload, the information in Create FTP Upload Schedule page 1100 may be stored in FTP history data 120 and accessed by clients 212 via View Upload History page 1200, as will be described in connection with in FIG. 12. Likewise, upon submission of an upload request, the information input to Create FTP Upload Schedule page 1100 may be accessed by clients 212 via View Upload Schedule page 1300, as will be explained in connection with FIG. 13.

FIG. 12 is a schematic diagram of an LFTS web page 1200 that displays upload history of files in accordance with one embodiment of the present invention. LFTS web page 1200, referred to as View Upload History page 1200, may be displayed in a table format, wherein each row 1202 (e.g., 1202a, . . . , 1202n) may correspond to a file uploaded, and include FTP Remote Server 1204 (e.g., 1204a, . . . , 1204n), FTP Remote File Path 1206 (e.g., 1206a, . . . , 1206n), LFTS File Name 1208 (e.g., 1208a, . . . , 1208n), LFTS File Path 1210 (e.g., 1210a, . . . , 1210n), Upload Started 1212 (e.g., 1212a, . . . , 1212n), Upload Finished 1214 (e.g., 1214a, . . . , 1214n), File Size 1216 (e.g., 1216a, . . . , 1216n), FTP File Date 1218 (e.g., 1218a, . . . , 1218n) and Upload Success 1220 (e.g., 1220a, . . . , 1220n). As FTP is used typically to upload a large quantity of text data file information, it may be necessary to check the integrity of the uploaded text data and display the checked integrity in an information field, such as Upload Success 1220 (e.g., 1220a, . . . , 1220n).

FIG. 13 is a schematic diagram of an LFTS web page 1300 that allows a user to view an upload schedule in accordance with one embodiment of the present invention. LFTS web page 1300, referred to as View Upload Schedule page 1300, may display data in a table format, wherein each row 1302 (e.g., 1302a, . . . , 1302n) may correspond to an upload request in an upload queue stored in upload schedule data 125. Each row 1302 (e.g., 1302a, . . . , 1302n) may have “View” button 1304 (e.g., 1304a, . . . , 1304n) and Upload Information field 1326 (e.g., 1326a, . . . , 1326n), wherein Upload Information field 1326 (e.g., 1326a, . . . , 1326n) may include FTP Remote Server 1306 (e.g., 1306a, . . . , 1306n), FTP Remote File Path 1308 (e.g., 1308a, . . . , 1308n), FTP File Date 1310 (e.g., 1310a, . . . , 1310n), Upload Start Date 1312 (e.g., 1312a, . . . , 1312n), Schedule Unit 1314 (e.g., 1314a, . . . , 1314n), Schedule Intervals 1316 (e.g., 1316a, . . . , 1316n), Upload End Date 1318 (e.g., 1318a, . . . , 1318n), LFTS File Path 1320 (e.g., 1320a, . . . , 1320n), LFTS File Name 1322 (e.g., 1322a, . . . , 1322n) and File Size 1324 (e.g., 1324a, . . . , 1324n). A user may click View button 1304 (e.g., 1304a, . . . , 1304n) to view the details of upload schedule and change upload parameters.

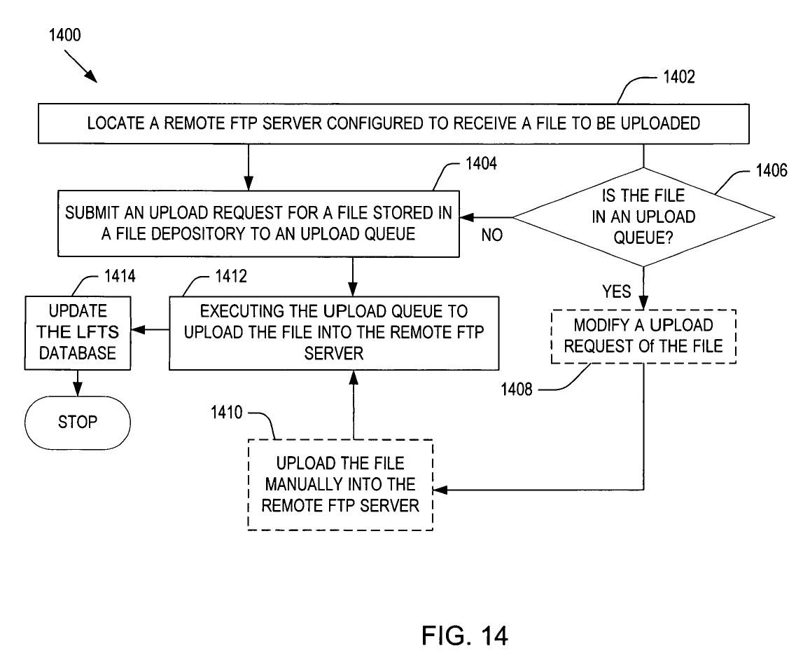

FIG. 14 is a flow chart 1400 illustrating steps that may be carried out to upload a file in accordance with one embodiment of the present invention. At step 1402, a user of client 212 may locate a remote FTP server for receiving a file to be uploaded. Then, the user may open a Create Upload Schedule page 1100 to submit an upload request for a file stored in a file depository at step 1404. Next, an LFTS program may execute the upload queue to upload the files at step 1412. Upon completion of file upload, the LFTS program may update the LFTS database, more specifically update the upload history data stored in the LFTS database.

Optionally, the user may open a View Upload Schedule page 1300 to check if an upload request for the file has been already submitted to an upload queue in the LFTS database at step 1406. If the answer to step 1406 is positive, the user may wait until the file is uploaded. As an optional step 1410, the user may modify the upload request in the upload queue. If the answer to step 1406 is negative, the user may proceed to step 1404 to submit an upload request. As an optional step 1414, the administrator of the LFTS database may manually upload the file in the upload queue.

While the present invention has been described with reference to the specific embodiments thereof, it should be understood, of course, that the foregoing relates to preferred embodiments of the invention and that modifications may be made without departing from the spirit and scope of the invention as set forth in the following claims.

What is claimed is:

1. A server system for managing transfer of files over a public network, the system comprising:
a file depository for centrally storing a plurality of files downloaded over the network; and
software configured to control downloading the plurality of files via a web-based user interface and centrally organizing storage of the plurality of files on the file depository.

2. The server system of claim 1, wherein the software comprises:
means for storing a download log of the plurality of files into file transfer history data; and
means for updating download schedule data including a download queue.

3. The server system of claim 2, further comprising a database for storing the file transfer history data and download schedule data.

4. The server system of claim 2, further comprising:
a task scheduler that executes the download queue.

5. The server system of claim 1, wherein the software comprises
means for checking the file depository for file existence; and
means for sending an error message to a user if the user submits a request for downloading one of the plurality of files.

6. The server of claim 1, further comprising an archive for storing one or more previous versions of the plurality of files;

7. The server system of claim 1, wherein the plurality of files are downloaded using File Transfer Protocol (FTP), Hypertext Transfer Protocol (HTTP), Hypertext Transfer Protocol Secure (HTTPS), Secure Socket Layer (SSL), Secure Shell (SSH), or Secure FTP.

8. The server system of claim 2, wherein the web-based user interface comprises one or more web pages to be displayed on at least one client system.

9. The server system of claim 8, wherein the one or more web pages include a page that allows a user to view the plurality of files and copy a selected one of the plurality of files into a directory of the at least one client system.

10. The server system of claim 9, wherein the page includes information of the plurality of files, the information comprising a file name, a file directory, a file size, a last download date, a file owner, a project name, a file description, a transfer date and a time of update.

11. The server system of claim 8, wherein the one or more web pages include a page that allows a user to browse the plurality of files in a hierarchically organized structure.

12. The server system of claim 8, wherein the one or more web pages include a page that allows a user to select one of a plurality of remote servers that host data to be downloaded.

13. The server system of claim 12, wherein the page includes information of the plurality of files, the information comprising an URL link, a FTP site name, a FTP server address/directory and a FTP site description.

14. The server system of claim 8, wherein the one or more web pages include a page that allows a user to submit a download request to the download queue, refresh the page or exit the page.

15. The server system of claim 14, wherein the page includes a plurality of user input fields, the plurality of user input fields comprising:
a FTP Remote Server section for inputting a name of a remote server and an IP address of the remote server;
a FTP Remote Server Directory/File section for selecting a directory and a file of the remote server;
a FTP Remote Server Path section for inputting a remote server path;
an LFTS Server Path section for inputting an Large File Transfer System (LFTS) server path;
an LFTS File Information section for inputting a file owner, a project name, and a file description; and
a Remote File Download Schedule section for selecting a download interval and an end date.

16. The server system of claim 8, wherein the one or more web pages include a page that allows a user to view the download log.

17. The server system of claim 16, wherein the page includes information of the plurality of files, the information comprising an address of a FTP remote server, a FTP remote file path, an Large File Transfer System (LFTS) file name, an LFTS file path, a time when a download started, a time when the download finished, a file size, a FTP file date and an indication of file integrity.

18. The server system of claim 8, wherein the one or more web pages include a page that allows a user to view the download queue.

19. The server system of claim 18, wherein the page includes information of the plurality of files, the information comprising an address of a FTP remote server, a FTP remote file path, a FTP file date, a date when a download started, a schedule unit, a schedule interval, a date when the download ended, a Large File Transfer System (LFTS) file path, an LFTS file name and a file size.

20. The server system of claim 8, wherein the one or more web pages include a page that allows an administrator of the server system to modify the download queue, edit one or more database fields, delete the plurality of files or manually download the plurality of files.

21. The server system of claim 20, wherein the page includes information of the download queue and two selection lists, wherein the information comprises an Large File Transfer System (LFTS) file path, an LFTS file name, a FTP remote server path, a FTP remote file path and a schedule unit and wherein the two selection lists include a Select Download Schedule Unit list and a Select Download Interval list.

22. The server system of claim 8, wherein the software comprises:
means for storing an upload log into the file transfer history data; and
means for updating upload schedule data including an upload queue.

23. The server system of claim 22, wherein the one or more web pages include a page that allows a user to submit an upload request to the upload queue.

24. The server system of claim 23, wherein the page includes a plurality of user input fields, the plurality of user input fields comprising:
a FTP Remote Server section for inputting an IP address of the remote server;
a Local File to Upload section for inputting a file to be uploaded;
an Large File Transfer System (LFTS) File Information section for inputting a file owner, a project name, and a file description;
a Remote File Upload Schedule section for selecting an upload interval and an end date; and
an Upload button that allows a user to confirm the upload request and send the upload request to the upload queue.

25. The server system of claim 22, wherein the one or more web pages include a page that allows a user to view the upload log.

26. The server system of claim 25, wherein the page includes information of the plurality of files, the information comprising an address of a FTP remote server, a FTP remote file path, an Large File Transfer System (LFTS) file name, an LFTS file path, a time when an upload started, a time when the upload finished, a file size, a FTP file date and an indication of file integrity.

27. The server system of claim 22, wherein the one or more web pages include a page that allows a user to view the upload queue.

28. The server system of claim 27, wherein the page includes information of the plurality of files, the information comprising an address of a FTP remote server, a FTP remote file path, a FTP file date, a date when an upload started, a schedule unit, a schedule interval, a date when the upload ended, an Large File Transfer System (LFTS) file path, an LFTS file name and a file size.

29. A method for downloading data in response to receiving a download request requesting a file to be downloaded, comprising:
adding the download request to a download queue;
comparing the file requested to be downloaded with one or more files contained in a file depository to determine if the file already exists in the file depository; and
if the file requested to be downloaded is not already in the file depository, downloading the file.

30. The method of claim 29, further comprising, prior to the step of adding the download request:
locating a remote FTP server hosting the file requested to be downloaded using a web-based user interface.

31. The method of claim 29, further comprising:
if the file is already in the file depository, checking a download history to determine if the file depository has the most recent version of the file.

32. The method of claim 29, further comprising, prior to the step of adding the download request:
checking if the download request is already in the download queue.

33. The method of claim 32, further comprising:
modifying the download request if the download request is already in the download queue.

34. The method of claim 29, wherein the step of downloading comprises:
downloading the file manually into the file depository.

35. The method of claim 29, wherein if the file already exists in the file depository, automatic downloading of the file is cancelled.

36. The method of claim 35, further comprising:
sending an error message to a user who submits the download request.

37. The method of claim 29, wherein the file is downloaded using File Transfer Protocol (FTP), Hypertext Transfer Protocol (HTTP), Hypertext Transfer Protocol Secure (HTTPS), Secure Socket Layer (SSL), Secure Shell (SSH), or Secure FTP.

38. A computer readable medium carrying one or more sequences of instructions for downloading data in response to receiving a download request requesting a file to be downloaded, wherein execution of one or more sequences of instructions by one or more processors causes the one or more processors to perform the steps of:
adding the download request to a download queue;
comparing the file requested to be downloaded with one or more files contained in a file depository to determine if the file already exists in the file depository; and
if the file requested to be downloaded is not already in the file depository, downloading the file.

39. The computer readable medium of claim 38, wherein execution of one or more sequences of instructions by one or more processors causes the one or more processors to perform the additional step of locating a remote FTP server hosting the file requested to be downloaded using a web-based user interface.

40. The computer readable medium of claim 38, wherein execution of one or more sequences of instructions by one or more processors causes the one or more processors to perform the additional step of checking, if the file is already in the file depository, a download history to determine if the file depository has the most recent version of the file.

41. The computer readable medium of claim 38, wherein execution of one or more sequences of instructions by one or more processors causes the one or more processors to perform the additional steps of checking if the download request is already in the download queue.

42. The computer readable medium of claim 38, wherein execution of one or more sequences of instructions by one or more processors causes the one or more processors to perform the additional steps of modifying the download request if the download request is already in the download queue.

43. The computer readable medium of claim 38, wherein execution of one or more sequences of instructions by one or more processors causes the one or more processors to perform the additional steps of sending an error message to a user.

44. A method for managing a database and a file depository that stores a plurality of files downloaded, comprising:
providing information of the plurality of files to at least one client;
receiving a download request for a specific file from the at least one client;
determining if the file depository has the specific file;
adding the download request to a download queue;
executing the download queue to download the specific file into the file depository; and
updating the file depository and the database containing the information.

45. The method of claim 44, wherein the step of executing the download queue comprises:
comparing a current date with a download date specified in the download request; and
if the current date is before the download date, downloading the specific file.

46. The method of claim 44, wherein the step of updating the file depository comprises:
determining if the file depository has a previous version of the specific file;
replacing the previous version with a current version of the specific file; and
storing the previous version into an archive.

47. The method of claim 46, further comprising:
if the file depository has the specific file, sending an error message to the at least one client.

48. The method of claim 44, wherein the information includes a file name, a file path, a file owner, a last download date, a file size, a file description and a file date of each of the plurality of files.

49. The method of claim 44, wherein the information is a tree structure of the plurality of files.

50. The method of claim 44, wherein the information includes a plurality of parameters specified in each download request of the download queue.

51. The method of claim 44, wherein the information includes a download history of each of the plurality of files.

52. The method of claim 44, further including, prior to the step of executing the download queue:
modifying the download queue.

53. The method of claim 44, further comprising:
repeating the step of providing information to the step of updating on a regular basis.

54. A computer readable medium carrying one or more sequences of instructions for managing a database and a file depository that stores a plurality of files downloaded, wherein execution of one or more sequences of instructions by one or more processors causes the one or more processors to perform the steps of:
providing information of the plurality of files to at least one client;
receiving a download request for a specific file from the at least one client;
determining if the file depository has the specific file;
adding the download request to a download queue;
executing the download queue to download the specific file into the file depository; and
updating the file depository and the database containing the information.

55. The computer readable medium of claim 54, wherein execution of one or more sequences of instructions by one or more processors causes the one or more processors to perform the additional step of sending an error message to the at least one client if the file depository has the specific file.

56. The computer readable medium of claim 54, wherein execution of one or more sequences of instructions by one or more processors causes the one or more processors to perform the additional step of modifying the download queue.

57. The computer readable medium of claim 54, wherein execution of one or more sequences of instructions by one or more processors causes the one or more processors to perform the additional step of repeating the step of providing information to the step of updating on a regular basis.

58. A method for uploading data, comprising:
locating a remote FTP server configured to receive a file to be uploaded using a web-based user interface;
submitting an upload request for the file to an upload queue; and
executing the upload queue to upload the file to the remote FTP server.

59. The method of claim 58, further comprising, prior to the step of submitting an upload queue:
checking if the upload request for the file is in the upload queue.

60. The method of claim 58, further comprising:
if the upload request for the file is in the upload queue, modifying the upload request.

61. The method of claim 58, further comprising:
uploading the file manually to the remote FTP server.

62. The method of claim 58, further comprising:
updating upload history data by adding upload information of the file to the upload history data.

63. The method of claim 58, wherein the file is uploaded using File Transfer Protocol (FTP), Hypertext Transfer Protocol (HTTP), Hypertext Transfer Protocol Secure (HTTPS), Secure Socket Layer (SSL), Secure Shell (SSH), or Secure FTP.

64. A computer readable medium carrying one or more sequences of instructions for uploading data, wherein execution of one or more sequences of instructions by one or more processors causes the one or more processors to perform the steps of:
locating a remote FTP server configured to receive a file to be uploaded using a web-based user interface;
submitting an upload request for the file to an upload queue; and
executing the upload queue to upload the file into the remote FTP server.

65. The computer readable medium of claim 64, wherein execution of one or more sequences of instructions by one or more processors causes the one or more processors to perform the additional step of uploading the file manually into the remote FTP server.

66. The computer readable medium of claim 64, wherein execution of one or more sequences of instructions by one or more processors causes the one or more processors to perform the additional step of modifying the upload request.

67. The computer readable medium of claim 64, wherein execution of one or more sequences of instructions by one or more processors causes the one or more processors to perform the additional step of updating upload history data by adding upload information of the file to the upload history data.
